(19) United States
(12) Patent Application Publication
(10) Pub. No.: US 2010/0072984 A1
(43) Pub. Date: Mar. 25, 2010

(54) INFLUENCING AND/OR DETECTING MAGNETIC PARTICLES IN A REGION OF ACTION OF AN EXAMINATION OBJECT

(75) Inventors: Bernhard Gleich, Hamburg (DE); Juergen Weizenecker, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/519,600

(22) PCT Filed: Dec. 17, 2007
(86) PCT No.: PCT/IB07/55163

§ 371 Date: Jun. 17, 2009

(30) Foreign Application Priority Data
Dec. 20, 2006 (EP) 06126580.7

(51) Int. Cl. G01N 27/74

(52) U.S. Cl. 324/204

(57) ABSTRACT

A method and an arrangement for influencing and/or detecting magnetic particles in a region of action of an examination object is disclosed, which method comprises the steps of: generating a magnetic selection field by means of selection means, the magnetic selection field having a pattern in space of its magnetic field strength such that a first sub-zone having a low magnetic field strength and a second sub-zone having a higher magnetic field strength are formed in the region of action, changing the position in space of the two sub-zones in the region of action by means of a magnetic drive field generated by drive means so that the magnetization of the magnetic particles change locally, acquiring signals by means of receiving means, which signals depend on the magnetization in the region of action, which magnetization is influenced by the change in the position in space of the first and second sub-zone, wherein the selection means and/or the drive means and/or the receiving means are provided at least partly movable relative to the examination object during the acquisition and/or the change in the position in space of the two sub-zones in the region of action.

The present invention relates to a method for influencing and/or detecting magnetic particles in a region of action of an examination object. Furthermore, the invention relates to an arrangement for influencing and/or detecting magnetic particles in a region of action of an examination object and to the use of such an arrangement.

A method for influencing and/or detecting magnetic particles is known from German Patent Application DE 101 51 778 A1. In the case of the method described in that publication, first of all a magnetic field having a spatial distribution of the magnetic field strength is generated such that a first sub-zone having a relatively low magnetic field strength and a second sub-zone having a relatively high magnetic field strength are formed in the examination zone. The position in space of the sub-zones in the examination zone is then shifted, so that the magnetization of the particles in the examination zone changes locally. Signals are recorded which are dependent on the magnetization in the examination zone, which magnetization has been influenced by the shift in the position in space of the sub-zones, and information concerning the spatial distribution of the magnetic particles in the examination zone is extracted from these signals, so that an image of the examination zone can be formed. Such an arrangement and such a method have the advantage that it can be used to examine arbitrary examination objects—e.g. human bodies—in a non-destructive manner and without causing any damage and with a high spatial resolution, both close to the surface and remote from the surface of the examination object.

There exists always the need to enlarge the field of possible applications of such a known arrangement by reducing the number of requirements in terms of required space or in terms of weight of the arrangement or parts thereof.

It is therefore an object of the present invention to provide a method giving a higher degree of flexibility to known methods.

The above object is achieved by a method for influencing and/or detecting magnetic particles in a region of action of an examination object, wherein the method comprises the steps of
generating a magnetic selection field by means of selection means, the magnetic selection field having a pattern in space of its magnetic field strength such that a first sub-zone having a low magnetic field strength and a second sub-zone having a higher magnetic field strength are formed in the region of action
changing the position in space of the two sub-zones in the region of action by means of a magnetic drive field generated by drive means so that the magnetization of the magnetic particles change locally,
acquiring signals by means of receiving means, which signals depend on the magnetization in the region of action, which magnetization is influenced by the change in the position in space of the first and second sub-zone,
   wherein the selection means and/or the drive means and/or the receiving means are provided at least partly movable relative to the examination object during the acquisition and/or the change in the position in space of the two sub-zones in the region of action.

The advantage of such a method is that it is possible to achieve a higher flexibility in the application of the method of magnetic particle imaging. For example, the cut of a (medical) cutting instrument can be viewed or followed by the inventive method during the movement of the cut.

According to a preferred embodiment of the present invention, the movement of at least a part of the selection means and/or of the drive means and/or of the receiving means is traced. Thereby, it is advantageously possible to continuously scan the region of action when there is a movement of the region of action relative to the examination object.

Furthermore, it is preferred according to the present invention that the tracing is performed by means of signal processing of the acquired signals and/or by means of optically and/or mechanically and/or electrically tracing the movement of at least a part of the selection means and/or of the drive means and/or of the receiving means. Thereby, it is advantageously possible to very flexibly track or trace the relative movement of the region of action and of the examination object.

The invention further relates to an arrangement for influencing and/or detecting magnetic particles in a region of action of an examination object, which arrangement comprises:

selection means for generating a magnetic selection field having a pattern in space of its magnetic field strength such that a first sub-zone having a low magnetic field strength and a second sub-zone having a higher magnetic field strength are formed in the region of action,

drive means for changing the position in space of the two sub-zones in the region of action by means of a magnetic drive field so that the magnetization of the magnetic particles changes locally,

receiving means for acquiring signals, which signals depend on the magnetization in the region of action, which magnetization is influenced by the change in the position in space of the first and second sub-zone,

wherein the selection means and/or the drive means and/or the receiving means are provided at least partly movable relative to the examination object.

With the inventive arrangement, it is advantageously possible to provide continuous measurements of the location and/or the distribution of the magnetic particles in a region of action while the region of action is moved relative to the examination object. The movement can also be performed e.g. by mechanically moving a permanent magnet as a part of the selection means.

According to a preferred embodiment of the present invention, the arrangement comprises tracing means for tracing the movement of the region of action relative to the examination object. Thereby, it is advantageously possible to expand the volume of the examination object without the need of large magnetic field generators like heavy coils or the like. This brings the possibility to provide the inventive arrangement lightweight and very flexible.

Furthermore according to a preferred embodiment of the present invention, the tracing means are realized by means of signal processing of the acquired signals and/or by means of optically and/or mechanically and/or electrically tracing the movement of at least a part of the selection means and/or of the drive means and/or of the receiving means. This enables to apply a multitude of different tracing or tracking techniques in order to allow the movement of the region of action relative to the examination object.

According to still a further preferred embodiment of the present invention, the arrangement comprises a medical instrument comprising at least part of the selection means and/or of the drive means and/or of the receiving means provided movable relative to the examination object. Thereby, a measurement of the distribution of the magnetic particles is possible, even in the case that the medical instrument (e.g. a scalpel or a scanning head or the like) is moved

According to another preferred embodiment of the present invention, the medical instrument comprises a ceramics part, especially a blade. Thereby, it is possible to use a material at least in parts of the medical instrument that does not provide distortions of the magnetic fields that are to strong to hinder the application of the inventive method or the use of the inventive arrangement.

The present invention is also related to the use of an inventive arrangement inside of a vehicle, especially an ambulance coach. This provides the possibility of a comparably high resolution imaging technique for diagnosis purposes inside a vehicle. This is especially useful for the case of stroke victims, where an early diagnosis is essential, because the choice of a suitable drug depends largely on the type of stroke. For hemorrhagic strokes, blood thinning drugs are contraindicated while they are highly beneficial for the embolic type of stroke. The earlier the diagnosis can be performed, the better are the chances for the patient to survive. An inventive arrangement used inside a vehicle and especially for the diagnosis of stroke victims is preferably arranged such that all components fit around the head of the patient.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

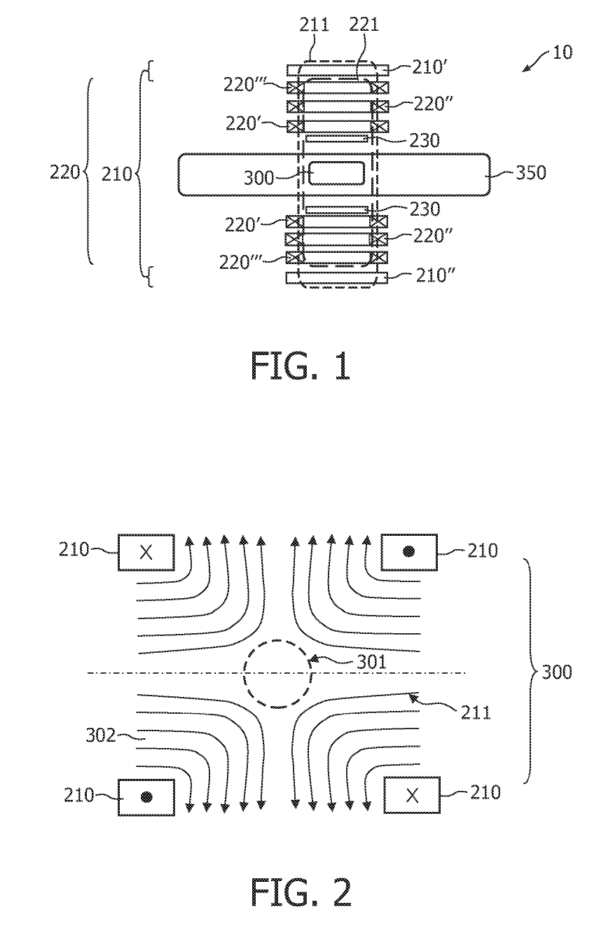

FIG. 1 illustrates an arrangement according to the present invention for carrying out the method according to the present invention.

FIG. 2 illustrates an example of the field line pattern produced by an arrangement according to the present invention

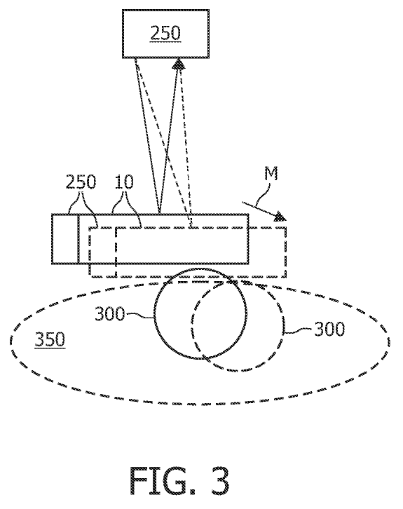

FIG. 3 illustrates different examples of tracing a movement of the region of action relative to the examination object.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

In FIG. 1, an arbitrary object to be examined by means of an arrangement 10 according to the present invention is shown. The reference numeral 350 in FIG. 1 denotes an object, in this case a human or animal patient, who is arranged on a patient table, only part of the top of which is shown. Prior to the application of the method according to the present invention, magnetic particles 100 (not shown in FIG. 1) are arranged in a region of action 300 of the inventive arrangement 10. Especially prior to a therapeutical and/or diagnostical treatment of, for example, a tumor, the magnetic particles 100 are positioned in the region of action 300, e.g. by means of a liquid (not shown) comprising the magnetic particles 100 which is injected into the body of the patient 350.

As an example of an embodiment of the present invention, an arrangement 10 is shown in FIG. 2 comprising a plurality of coils forming a selection means 210 whose range defines the region of action 300 which is also called the region of examination 300. For example, the selection means 210 is arranged above and below the object 350. For example, the selection means 210 comprise a first pair of coils 210′, 210″, each comprising two identically constructed windings 210′ and 210″ which are arranged coaxially above and below the patient 350 and which are traversed by equal currents, especially in opposed directions. The first coil pair 210′, 210″ together are called selection means 210 in the following. Preferably, direct currents are used in this case. The selection means 210 generate a magnetic selection field 211 which is in general a gradient magnetic field which is represented in FIG. 2 by the field lines. It has a substantially constant gradient in the direction of the (e.g. vertical) axis of the coil pair of the selection means 210 and reaches the value zero in a point on this axis. Starting from this field-free point (not individually shown in FIG. 2), the field strength of the magnetic selection field 211 increases in all three spatial directions as the distance increases from the field-free point. In a first sub-zone 301 or region 301 which is denoted by a dashed line around the field-free point the field strength is so small that the magnetization of the magnetic particles 100 present in that first sub-zone 301 is not saturated, whereas the magnetization of the magnetic particles 100 present in a second sub-zone 302 (outside the region 301) is in a state of saturation. The field-free point or first sub-zone 301 of the region of action 300 is preferably a spatially coherent area; it may also be a punctiform area or else a line or a flat area. In the second sub-zone 302 (i.e. in the residual part of the region of action 300 outside of the first sub-zone 301) the magnetic field strength is sufficiently strong to keep the magnetic particles 100 in a state of saturation. By changing the position of the two sub-zones 301, 302 within the region of action 300, the (overall) magnetization in the region of action 300 changes. By measuring the magnetization in the region of action 300 or a physical parameter influenced by the magnetization, information about the spatial distribution of the magnetic particles 100 in the region of action can be obtained.

When a further magnetic field—in the following called a magnetic drive field 221 is superposed on the magnetic selection field 210 (or gradient magnetic field 210) in the region of action 300, the first sub-zone 301 is shifted relative to the second sub-zone 302 in the direction of this magnetic drive field 221; the extent of this shift increases as the strength of the magnetic drive field 221 increases. When the superposed magnetic drive field 221 is variable in time, the position of the first sub-zone 301 varies accordingly in time and in space. It is advantageous to receive or to detect signals from the magnetic particles 100 located in the first sub-zone 301 in another frequency band (shifted to higher frequencies) than the frequency band of the magnetic drive field 221 variations. This is possible because frequency components of higher harmonics of the magnetic drive field 221 frequency occur due to a change in magnetization of the magnetic particles 100 in the region of action 300 as a result of the non-linearity of the magnetization characteristics, i.e. the due to saturation effects.

In order to generate the magnetic drive field 221 for any given direction in space, there are provided three drive coil pairs, namely a first drive coil pair 220′, a second drive coil pair 220″ and a third drive coil pair 220′ which together are called drive means 220 in the following. For example, the first drive coil pair 220′ generates a component of the magnetic drive field 221 which extends in a given direction, i.e. for example vertically. To this end the windings of the first drive coil pair 220′ are traversed by equal currents in the same direction. The two drive coil pairs 220″, 220′″ are provided in order to generate components of the magnetic drive field 221 which extend in a different direction in space, e.g. horizontally in the longitudinal direction of the region of action 300 (or the patient 350) and in a direction perpendicular thereto. If second and third drive coil pairs 220″, 220′ of the Helmholtz type were used for this purpose, these drive coil pairs would have to be arranged to the left and the right of the region of treatment or in front of and behind this region, respectively. This would affect the accessibility of the region of action 300 or the region of treatment 300. Therefore, the second and/or third magnetic drive coil pairs or coils 220″, 220′″ are also arranged above and below the region of action 300 and, therefore, their winding configuration must be different from that of the first drive coil pair 220′. Coils of this kind, however, are known from the field of magnetic resonance apparatus with open magnets (open MRI) in which a radio frequency (RF) drive coil pair is situated above and below the region of treatment, said RF drive coil pair being capable of generating a horizontal, temporally variable magnetic field. Therefore, the construction of such coils need not be further elaborated herein.

The arrangement 10 according to the present invention further comprise receiving means 230 that are only schematically shown in FIG. 1. The receiving means 230 usually comprise coils that are able to detect the signals induced by the magnetization pattern of the magnetic particle 100 in the region of action 300. Coils of this kind, however, are known from the field of magnetic resonance apparatus in which e.g. a radio frequency (RF) coil pair is situated around the region of action 300 in order to have a signal to noise ratio as high as possible. Therefore, the construction of such coils need not be further elaborated herein.

Such an arrangement and such a method of detecting magnetic particles are known from DE 101 51 778 which is hereby incorporated in its entirety.

Further arrangements 10 for performing magnetic particle imaging are known from the document WO 2006/067692 A2 which is hereby incorporated by reference in its entirety. This document discloses the use of the overall concept of magnetic particle imaging by transferring at least a part of the selection means 210, the drive means 220 and/or the receiving means 230 to a handheld device, e.g. a medical instrument.

In one aspect of the present invention, a part of the arrangement 10 is also transferred to a handheld or otherwise mobile device which is movable relative to the object of examination 350. According to the method and the arrangement 10 of the present invention, it is possible to determine a movement of the region of action 300 relative to the examination object 350 by tracking or tracing the movement of the mobile device or the handheld. Thereby, it is possible to strongly reduce the equipment needed in an arrangement 10 for influencing and/or detecting magnetic particles according to the method of magnetic particle imaging. In the case where the movement of the first sub-zone 301 in the region of action 300 by means of the drive means 220 covers only a relatively small volume of e.g. several 10 cubic centimetres and there exists the need for a larger volume to scan, the use of further (comparably bulky and costly) magnetic field generating means would be a possibility. The integration of such supplementary magnetic field generating means in a handheld device is very difficult if not impossible. According to one aspect of the present invention, it is therefore suggested to use the movement of the handheld device in order to enlarge the volume to scan. In order to link the different regions of the size of the region of action 300 which is scannable at once (or at least comparably quickly), the inventive arrangement 10 preferably comprises a tracing means 250 for tracing the movement of the movable part of the arrangement 10, e.g. the handheld part.

In FIG. 3, different examples or possibilities of tracing a movement M of the region of action 300 relative to the examination object 350 are depicted schematically. The movement M of the region of action 300 corresponds to a movement M of the arrangement 10 or at least a part thereof, e.g. a handheld device comprising at least a part of the selection means 210, of the drive means 220 and/or of the receiving means 230. The location of the moved region of action 300 and the moved arrangement 10 or part of the arrangement 10 is denoted by small-dashed lines in FIG. 3.

Several possibilities exist in order to determine the movement M. According to one aspect of the present invention, this can be done by tracing means 250 determining e.g. the acceleration and deceleration of the part of the arrangement 10, e.g. an accelerometer (not depicted) and preferably mounted to the handheld device. Furthermore, the movement can be trace by optical means, e.g. by a laser beam (schematically shown by means of an exterior housing of the tracing means 250 and arrows detecting the position of the arrangement 10 or a part thereof). Likewise, it is possible that a mechanical embodiment of the tracing means 250 is provided, e.g. a mechanical transmission of the movement M.

According to another possibility, the movement M can be detected by means of reconstructing the volume to be scanned by means of regions thereof that have already been scanned. This can be understood in the following manner: The region of action 300 is moved a sufficiently small distance in order to provide an overlap region 300′ of the region of action 300 before the movement has been performed and the region of action 300 after the movement has been performed. If the supposition is justified that e.g. the distribution of the magnetic particles 100 has not changed dramatically during the time the movement was performed, then the information of the overlap region 300′ can be used by a suitable signal processing in order to enlarge the scannable region, e.g. by means adding a new volume (which was not covered at the position of the region of action 300 before the movement M) to the image of the scanned region.

According to the present invention, either one or a plurality of different tracing methods can be used in order to determine the position of the arrangement 10 or the part of the arrangement after the movement M. Furthermore, it is possible that the different possibilities of tracing are combined such that for long range movements only or preferably one kind of tracing means 250 is used and for short range movements only or preferably another kind of tracing means 250 is used, e.g. the tracing means using signal processing only for short range and relatively fast movements. The recorded signal of the enlarged region which had been an interaction with the region of action 300 during the movement, can then be used to form a well spatially resolved tomographic image, e.g. of a part of the body of a patient. In addition, the recorded signals may also be represented optically or acoustically allowing for fast determination of localized particle concentrations. Thereby, an effective detection of special body tissues or other objects over a relatively large volume is possible, e.g. sentinel lymph node detection.

Furthermore, according to another aspect of the present invention, a medical instrument (not shown), e.g. a surgical device, can be provided with at least part of the receiving means 230 of an arrangement 10 for magnetic particle imaging. Thereby, it is possible to directly detect and localize the presence or not of magnetic particles 100 in the environment of the medical instrument. For example, it is advantageous to provide the medical instrument at least partly using ceramics, e.g. a part forming a blade of the medical instrument can be provided using ceramics. The receiving means 230 or part thereof (e.g. in the form of a receiving coil) can advantageously be positioned near the ceramics part such that the harmonics produced by an applied magnetic drive field 221 can be detected, e.g. when an amplifier integrated in the medical instrument. The drive field 221 can either be generated by a source on the medical instrument, e.g. in the shaft, or it is generated by an external source. In the case of an external generation, the medical instrument needs no cable connections and can be powered by battery. To improve the localisation of the magnetic particles 100, a selection field generator (e.g. a permanent magnet) as part of the selection means 210 can be used completely or partly as a part of the medical instrument, e.g. one pole of the selection field generator. This selection field generator on the medical instrument can e.g. provided mechanically adjustable to move the sensitive spot to the desired position relative to the device, which is best for the intended intervention.

According to a further aspect of the present invention, an inventive arrangement 10 is used inside of a vehicle (not shown), especially an ambulance coach. An inventive arrangement 10 used inside a vehicle and especially for the diagnosis of stroke victims is preferably arranged such that all components fit around the head of the patient. According to this aspect of the present invention, permanent magnets as parts of the selection means 210 can be provided such that they are moved mechanically in order to move the region of action 300. The amplitude of the drive fields is in this case preferably restricted to comparably low values, e.g. lower than about 20 mT. The gradient of the selection field can be quite low, e.g. lower than about 1 Tesla per meter, owing to the fact that the required spatial resolution is not too high. This allows a reasonable field of view despite the low drive field amplitudes. Especially, the static magnetic field of the selection field generator as part of the selection means 210 and the magnetic drive field 221 of the drive means 220 are actively shielded to minimize interference with other equipment of the vehicle. To reduce artifacts in the acquired image, the coach is provided with a radio frequency shielding material, that can e.g. be placed inside the doors of the vehicle.

1. A method for influencing and/or detecting magnetic particles (100) in a region of action (300) of an examination object (350), wherein the method comprises the steps of
generating a magnetic selection field (211) by means of selection means (210), the magnetic selection field (211) having a pattern in space of its magnetic field strength such that a first sub-zone (301) having a low magnetic field strength and a second sub-zone (302) having a higher magnetic field strength are formed in the region of action (300)
changing the position in space of the two sub-zones (301, 302) in the region of action (300) by means of a magnetic drive field (221) generated by drive means (220) so that the magnetization of the magnetic particles (100) change locally,
acquiring signals by means of receiving means (230), which signals depend on the magnetization in the region of action (300), which magnetization is influenced by the change in the position in space of the first and second sub-zone (301, 302),
wherein the selection means (210) and/or the drive means (220) and/or the receiving means (230) are provided at least partly movable relative to the examination object (350) during the acquisition and/or the change in the position in space of the two sub-zones (301, 302) in the region of action (300).

2. A method according to claim 1, wherein the movement of at least a part of the selection means (210) and/or of the drive means (220) and/or of the receiving means (230) is traced.

3. A method according to claim 2, wherein the tracing is performed by means of signal processing of the acquired signals.

4. A method according to claim 2, wherein the tracing is performed by means of optically and/or mechanically and/or electrically tracing the movement of at least a part of the selection means (210) and/or of the drive means (220) and/or of the receiving means (230).

5. An arrangement (10) for influencing and/or detecting magnetic particles (100) in a region of action (300) of an examination object (350), which arrangement comprises:
selection means (210) for generating a magnetic selection field (211) having a pattern in space of its magnetic field strength such that a first sub-zone (301) having a low magnetic field strength and a second sub-zone (302) having a higher magnetic field strength are formed in the region of action (300),
drive means (220) for changing the position in space of the two sub-zones (301, 302) in the region of action (300) by means of a magnetic drive field (221) so that the magnetization of the magnetic particles (100) changes locally,
receiving means (230) for acquiring signals, which signals depend on the magnetization in the region of action (300), which magnetization is influenced by the change in the position in space of the first and second sub-zone (301, 302),
wherein the selection means (210) and/or the drive means (220) and/or the receiving means (230) are provided at least partly movable relative to the examination object (350).

6. An arrangement according to claim 5, wherein the arrangement (10) comprises tracing means (250) for tracing the movement.

7. An arrangement according to claim 6, wherein the tracing means (250) are realized by means of signal processing of the acquired signals.

8. An arrangement according to claim 6, wherein the tracing means (250) are realized by means of optically and/or mechanically and/or electrically tracing the movement of at least a part of the selection means (210) and/or of the drive means (220) and/or of the receiving means (230).

9. An arrangement according to claim 8, wherein the tracing means (250) comprises an acceleration sensor.

10. An arrangement according to claim 5, wherein the arrangement (10) comprises a medical instrument comprising at least part of the selection means (210) and/or of the drive means (220) and/or of the receiving means (230) provided movable relative to the examination object (350).

11. An arrangement according to claim 10, wherein the medical instrument comprises a ceramics part, especially a blade.

12. The use of an arrangement (10) according to claim 5 inside of a vehicle, especially an ambulance coach.
